(19) United States
(12) Patent Application Publication
(10) Pub. No.: US 2005/0011882 A1
(43) Pub. Date: Jan. 20, 2005

(54) Electric mat using regenerative material

(76) Inventor: Jun-Hyong Kim, Songpa-gu (KR)

Correspondence Address: JORDAN AND HAMBURG LLP, 122 EAST 42ND STREET, SUITE 4000, NEW YORK, NY, 10168, US

(21) Appl. No.: 10/644,474

(22) Filed: Aug. 20, 2003

(30) Foreign Application Priority Data
Jul. 15, 2003 (KR) 48445/2003

(51) Int. Cl. H05B 3/34

(52) U.S. Cl. 219/528

(57) ABSTRACT

The present invention relates to an electric mat using a regenerative material which includes an adiabatic member installed in a bottom of the electric mat, a heating hose provided on the adiabatic member at a certain interval, an electric heat cord which is arranged in a concave portion of the heating hose, an electric heat plate stacked on an upper portion of the heating hose, a silver fiber layer stacked on an upper portion of the heating hose, a yellow soil cover layer arranged on an upper portion of the silver fiber layer, a finishing member which covers an upper side of the yellow soil cover layer, a controller for controlling a temperature of the electric mat, and a connection means for engaging the electric mat and the controller. In the present invention, since an electric heat cord does not contact with a regenerative material, it is possible to prevent a fire and an electric leakage. In addition, since a regenerative material radiates an infrared ray, it is possible to implement an environment friendly heating operation. The power consumption is low, so that it is possible to significantly decrease the energy. Therefore, an economical operation of the system is implemented.

### BACKGROUND OF THE INVENTION

1. Field of the Invention

The present invention relates to an electric mat using a regenerative material, and in particular to an electric mat which is capable of preventing a fire and an electric leakage by preventing a contact between a regenerative material and an electric heat coil, so that it is possible to prevent a corrosion of an electric heat coil.

2. Description of the Background Art

Generally, an electric mat includes an electric heat coil in a heating hose and is basically directed to a heating unit which uses a low cost electricity compared to an expensive fuel such as an oil, gas, etc.

However, in a conventional electric mat, since an electric heat cord is provided in the interior of a heating hose, the electric mat has only a heating function and heat transfer function. In addition, since a heating operation of an electric heat cord and a maintaining of a heated state are dependent only on a power supply, a power consumption is increased in order to maintain an increased temperature for a long time.

In order to overcome the above objects, there is provided Korean utility model laid-open No. 96-33085(Laid-open date: Oct. 24, 1996, and the inventor is Kim, Han-Joong). In an electric under-floor heating panel, a semi-circular pipe which has a groove in a center portion of the same is formed in an upper and lower side, and an electric heat cord is inserted into the center of the semi-circular pipe, and then a heat conduction cover plate is engaged on an upper side of the same.

However, since the above electric under-floor heating plate does not have a heat absorption pipe like in a conventional electric mat, the heat generated by the electric heat cord is directly transferred through a metal, the temperature increase is fast implemented compared to a certain liquid which has a high specific heat. However, in order to maintain the increased temperature, a heated state of the electric heat cord should be continuously maintained, so that a power consumption is increased. In addition, since an electric heat cord is inserted between metallic rods, if a certain part of the electric heat cord is exposed, an electric shock or electric leakage may occur.

In order to overcome the above problem, there is provided Korean patent No. 338,924(Laid-open date: May 30, 2002, and the inventor is Lee, Byung-Whan). The electric boiler mat includes an adiabatic member formed of a polyurethane material, a heating hose which has an electric heat cord and regenerative material which are arranged on the adiabatic member, an electric heat plate provided on an upper side of the adiabatic member and contacting with the heating hose, a plate shaped wormwood pack provided on an upper side of the electric heat cord, and a heat radiating plate provided on an upper side of the wormwood pack. In addition, there are further provided a temperate detector provided in the interior of the heating hose and detecting the temperature, and a temperature controller which is provided in a certain portion of an angle box and controls the temperature of the heating hose based on a temperature value detected by the temperature detector.

However, in the above electric boiler mat, since the heating hose having an electric heat cord and a regenerative material on an adiabatic member is arranged and then an electric power is supplied, if the regenerative material is directly contacted or a part of the electric heat cord is exposed, a fire or power leakage may occur, so that there may be a certain safety problem. In addition, a cap adapted to sealingly plug both ends of the heating hose may be separated, so that a regenerative material may be leaked out.

### SUMMARY OF THE INVENTION

Accordingly, it is an object of the present invention to provide an electric mat using a regenerative material which overcomes the problems countered in the conventional art.

It is another object of the present invention to provide an electric mat using a regenerative material which is capable of fully preventing a fire and electric leakage by separately installing a heating hose having a regenerative material therein and an electric heat cord and preventing a corrosion of an electric heat cord which may occur due to a regenerative material.

It is further another object of the present invention to provide an electric mat which is capable of separating a heating hose installed on an adiabatic member into a straight line portion and a curved line portion and then assembling the same.

It is still further another object of the present invention to provide an environment friendly heating apparatus which is capable of preventing a propagation of bacteria in a heating system by using a silver fiber and yellow soil.

It is still further another object of the present invention to provide an electric mat which includes a controller adapted to accurately control a temperature of an electric mat and stably use the same.

To achieve the above objects, in an electric mat which includes a heating hose in which a regenerative material is filled, an electric heat cord provided in the electric heat hose, a temperature detector and an indoor temperature detector for detecting a temperature of the interior of a regenerative material, there is provided an electric mat using a regenerative material which comprises an adiabatic member installed in a bottom of the electric mat, a heating hose provided on the adiabatic member at a certain interval, an electric heat cord which is arranged in a concave portion of the heating hose, an electric heat plate stacked on an upper portion of the heating hose, a silver fiber layer stacked on an upper portion of the heating hose, a yellow soil cover layer arranged on an upper portion of the silver fiber layer, a finishing member which covers an upper side of the yellow soil cover layer, a controller for controlling a temperature of the electric mat, and a connection member for engaging the electric mat and the controller.

In the present invention, a concave portion is formed in a center of a bottom surface of the heating hose, and another surface of the same is formed in a semi circular shape or a rectangular shape, and an electric heat cord is arranged in a space formed in the concave portion in a longitudinal direction, and a plugging cap hermetically seals both ends of the heating hose.

In addition, the heating hose is formed of an upper hose and a lower hose each having a concave portion formed in a center in a longitudinal direction, and the upper hose has an engaging groove formed in one side, and the lower hose has an engaging portion corresponding to the engaging groove, and an electric heat cord is inserted in the center, and the engaging groove and the engaging portion are engaged each other, and then a plugging cap is hermitically engaged to both ends of the heating hose.

The heating hose is assembled in such a manner that a straight line type heating hose and a curve line type heating hose are engaged each other. In the case that the straight line shape heating hose and the curve shaped heating hose are assembled, a wrinkled light weight steel plate or a plane type insulation plate may be stacked at both sides of the heating hose or both sides of the heating hose may be surrounded by the plane type insulation plate. The electric mat according to the present invention may be adapted to a movable type house or a common home heating apparatus or a wall unit.

### BRIEF DESCRIPTION OF THE DRAWINGS

The present invention will become better understood with reference to the accompanying drawings which are given only by way of illustration and thus are not limitative of the present invention, wherein;

FIG. 1 is a disassembled perspective view illustrating an electric mat according to the present invention;

FIG. 2 is a cross sectional view which illustrates an electric mat and is taken along line II-II′ of FIG. 1;

FIGS. 3A and 3B are cross sectional views illustrating a heating hose according to a first embodiment of the present invention;

FIG. 4A is a view illustrating a connection unit for engaging an electric mat and a controller according to the present invention;

FIG. 4B is a disassembled perspective view of FIG. 4A;

FIG. 5 is a block diagram illustrating an electric circuit with respect to a controller according to the present invention;

FIG. 6A is a perspective view illustrating a heating hose of an electric mat according to a second embodiment of the present invention;

FIG. 6B is a disassembled view of FIG. 6A;

FIG. 6C is a cross sectional view which illustrates a heating hose of an electric mat and is taken along line IV-IV′ of FIG. 6A;

FIG. 6D is a view illustrating an example that the construction of FIG. 6A is adapted to a wrinkling light weight plate;

FIG. 7 is a view illustrating the construction according to a third embodiment of the present invention;

FIG. 8 is a perspective view illustrating the construction that an electric mat is adapted to a bed according to a fourth embodiment of the present invention;

FIG. 9 is a perspective view illustrating the construction that an electric may is used as an indoor heating unit according to the present invention; and

FIG. 10 is a graph which shows a comparison between the energy consumption rates of a heating related units.

### DETAILED DESCRIPTION OF THE PREFERRED EMBODIMENTS

The preferred embodiments of the present invention will be described with reference to the accompanying drawings.

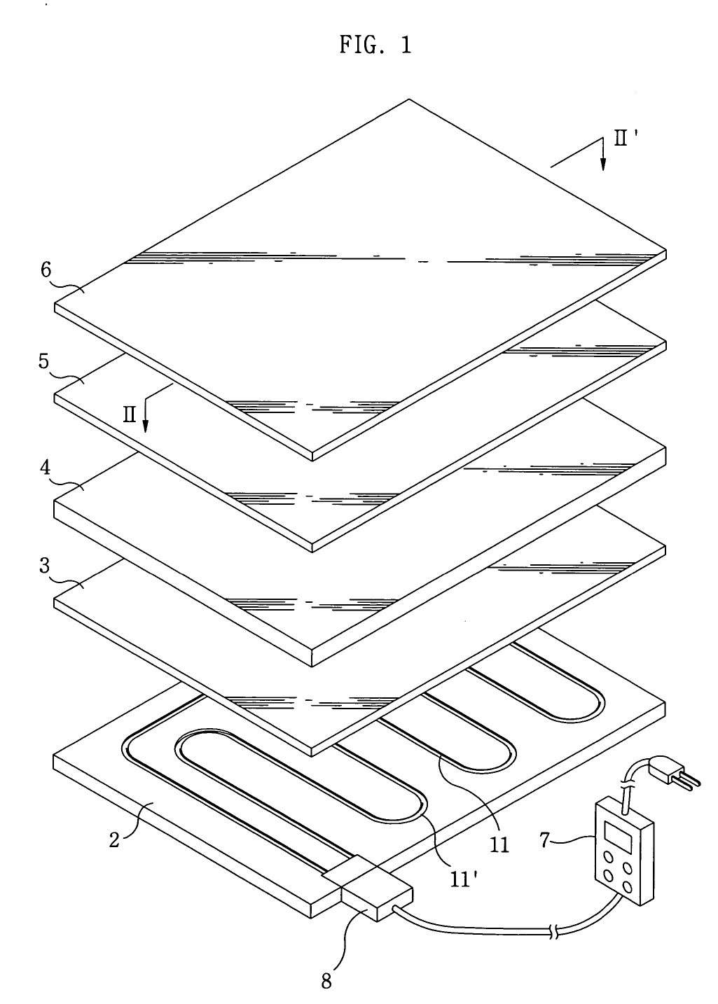

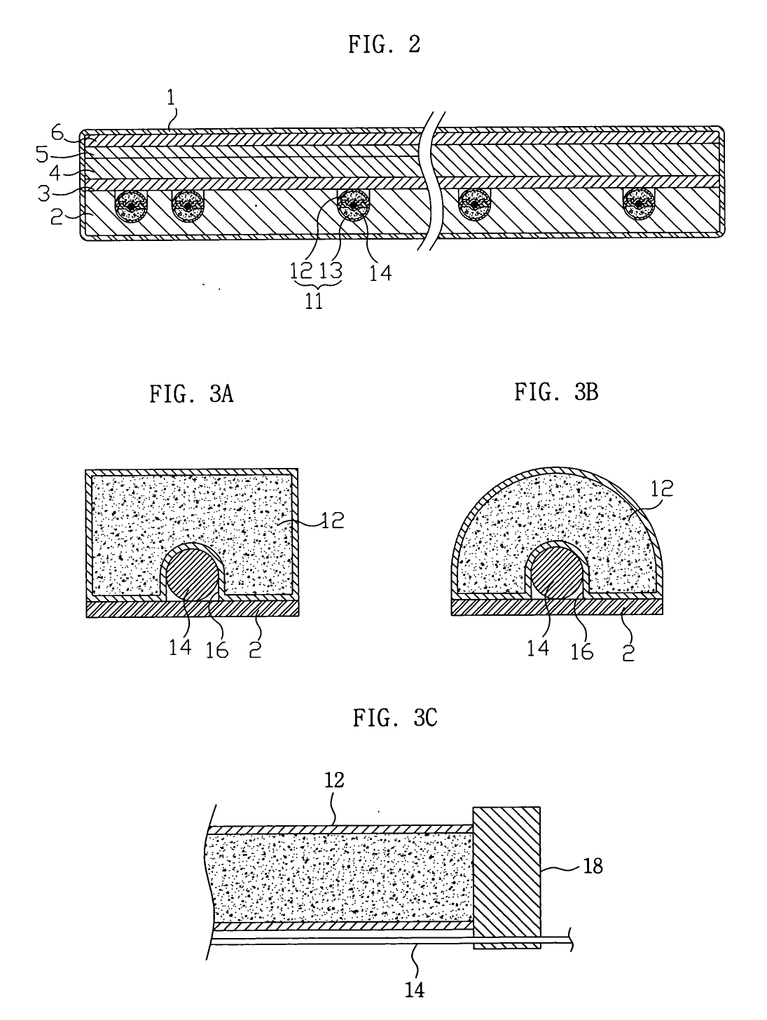

FIG. 1 is a disassembled perspective view illustrating an electric mat according to the present invention, FIG. 2 is a cross sectional view which illustrates an electric mat and is taken along line II-II′ of FIG. 1, and FIGS. 3A and 3B are cross sectional views illustrating a heating hose according to a first embodiment of the present invention.

As shown in FIGS. 1 and 2, an electric mat 1 according to the present invention includes an adiabatic member 2. A plurality of grooves are formed in the adiabatic member 2, and a heating hose 11 is provided therein in a zig-zag shape. Thereafter, an electric heat plate 3, a silver fiber layer 4, a yellow soil cover layer 5 and a finishing material 6 are sequentially stacked on the upper portion of the heating hose 11.

Here, a regenerative material is preferably formed by dissolving salt in water. Therefore, the regenerative material has a salted liquid of 70% through 90%. Since the regenerative material has a CaCl₂ component which has an excellent regenerative characteristic, there is an excellent effect for increasing a temperature and maintaining an increased temperature.

The component ratio of a mixture of the regenerative material according to the present invention is salt(NaCl) of 60˜70 weight %, water(H₂O) of 20˜30 weight %, NaOH of 5 weight %, and Ca₃COOH of 5 weight %. Here, NaOH and Ca₃COOH may be selectively used.

Here, since the regenerative material used as a regenerative material contains a calcium chloride component which has an excellent regenerative characteristic, it is possible to maintain an increased temperature for a long time using less electric energy for thereby implementing an excellent heating effect. In addition, since infrared rays occur in a regenerative material, a blood circulation is activated in a human body.

The electric heat plate 3 is formed of a metallic plate material such as a copper plate having an excellent heat conduction characteristic. The electric heat plate 3 receives a heat from the upper hose 12.

The silver fiber layer 4 is formed in a rectangular shape by processing a fiber having a silver powder component through a certain fabrication process. Since the silver fiber layer 4 is attached to an upper side of the electric heat plate 3, it is possible to prevent a propagation of bacteria in the electric mat 1 and a bad smell. In order to implement a smell removing and bacteria sterilizing effect, a certain member or a pack formed of a wormwood or a certain herb may be used instead of the silver fiber layer.

The yellow soil cover layer 5 is fabricated in such a manner that a yellow soil is absorbed to a fiber having a cotton or hemp, and a resultant material is cut into a certain size. The yellow soil cover layer 5 is capable of emitting an infrared ray which is largely contained in a yellow soil in a state that the yellow soil cover layer 5 is attached to an upper side of the silver fiber layer 4.

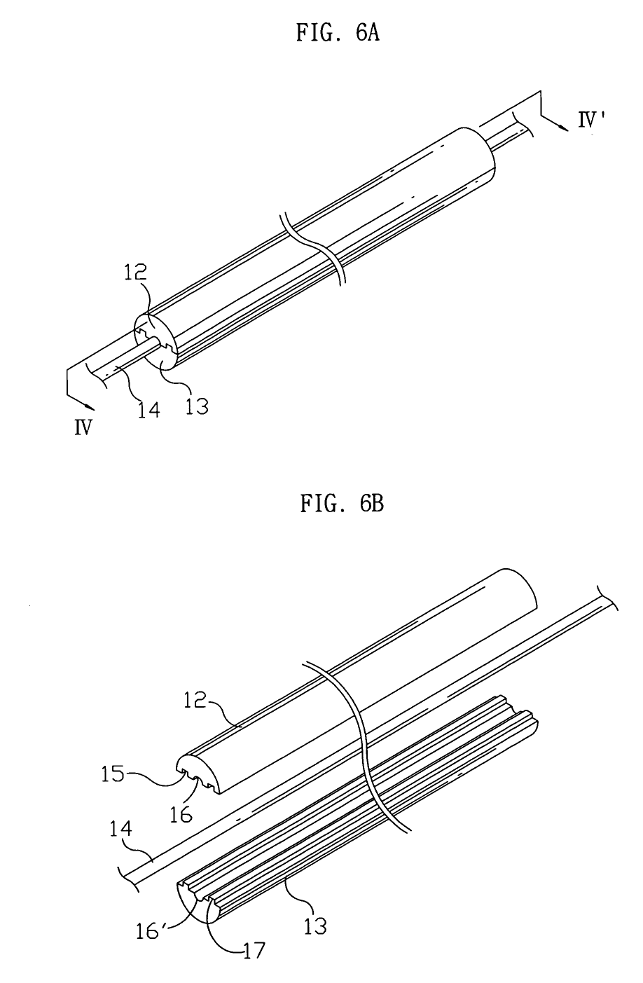

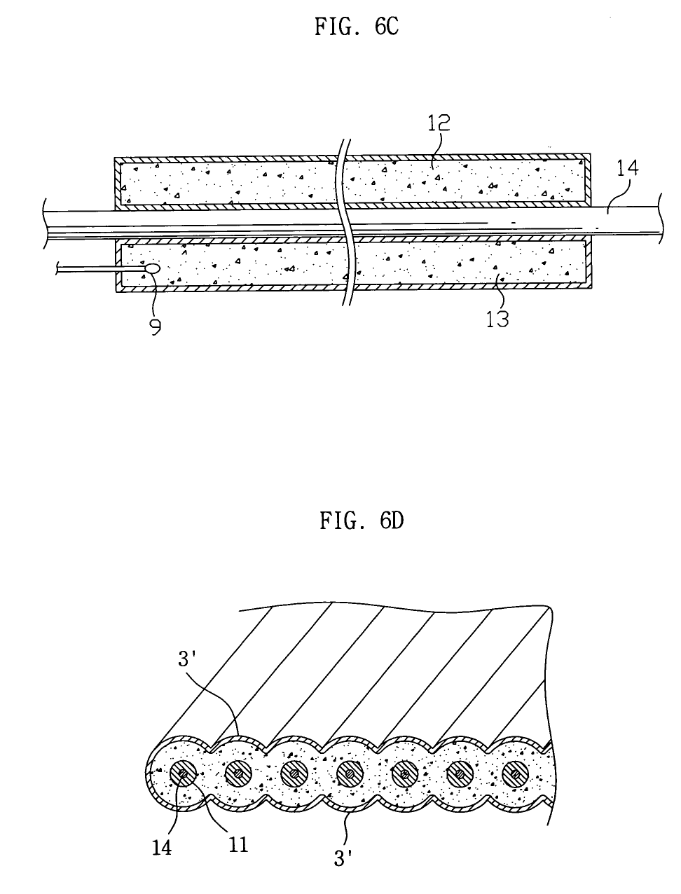

The electric mat 1 is finished by forming a finishing material on an upper portion of the yellow soil cover layer 5. As shown in FIG. 6C, the temperature detector 9 is installed in the heating hose 11 and is connected with an input terminal of the controller 7. Namely, a connection line of the temperature detector 9 is connected with an input terminal of the controller 7 through a through hole of the plugging cap 18.

An output terminal of the controller 7 is connected with the power apparatus 28, and an input terminal of the same is connected by a connection member 8 connected with the electric heat cord 14 provided in the heating hose 11.

In the above construction, in the electric mat 1 according to the present invention, when a power is supplied to the electric heat cord 14 provided in the space formed in the heating hose 11, the electric heat cored 14 is heated for thereby heating the heating hose 11, and then the temperature of the regenerative material filled in the heating hose is increased. As the temperature of the regenerative material is increased, the heat is transferred to the electric heat cord 3, and the heat is transferred to the outside through the silver fiber layer 4, the yellow soil cover layer 5 and the finishing material 6 provided on the upper portion of the electric heat cord 3 for thereby implementing a desired heating operation.

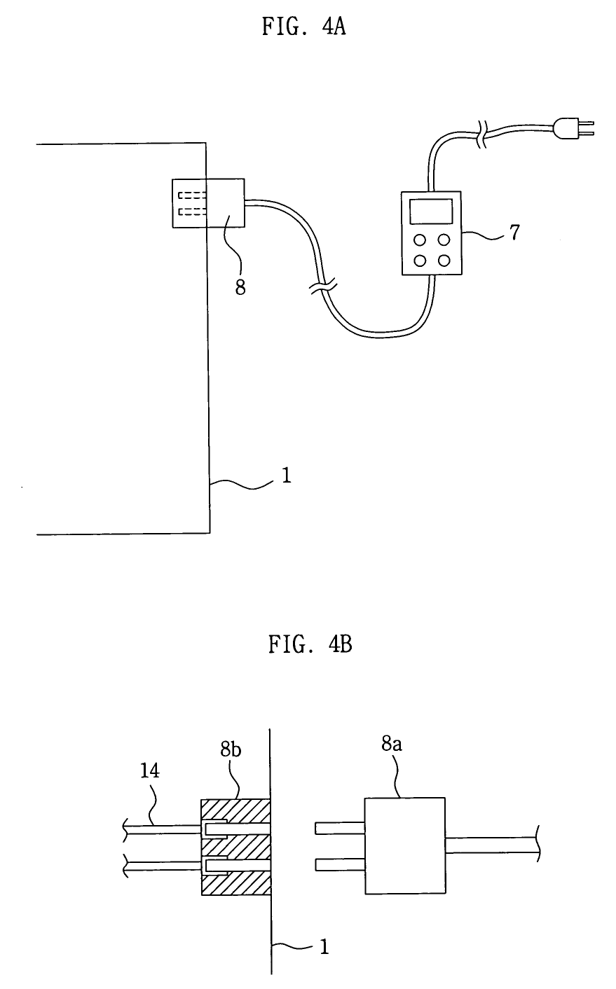

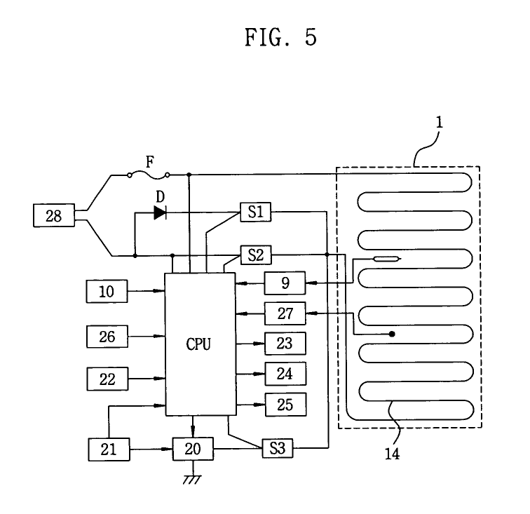

FIG. 4A is a view illustrating the construction with respect to a connection member which connects the electric mat and the controller, and FIG. 4B is a disassembled perspective view of FIG. 4A. The connection member 8 adapted to electrically connect the electric mat 1 and the controller 7 is formed of a consent 14 which is provided in an output terminal provided at a certain distance from the electric mat 1 and is directly connected with the electric heat cord 14, and a plug which is attached to an input terminal of the controller 7 and is connected with an electric cable.

In the case that multiple electric mats are intended to use, the connection member 8 is additionally provided in the opposite position of the electric mat, and the plug 8a is engaged instead of the consent 8b.

As shown therein, there are provided a temperature setting unit 26 installed in an input terminal of the controller 7 engaged with various electric devices about a micro computer(CPU) for setting a heating temperature, and an indoor temperature detector 10 installed in the indoor for detecting an indoor temperature. In addition, the temperature detector 9 adapted to detect the temperature of a regenerative material of the heating hose 11 and the regenerative material detector 27 are electrically connected.

An output terminal of the controller 7 is connected with a power indication lamp 23 for thereby checking an operation state of the controller 7, and an operation indication lamp 24 is connected with another output terminal of the controller 7 for thereby checking an operation of the electric heat cord 14. An alarm unit 25 is connected with further another output terminal of the controller 7, so that when a certain error occurs in the electric mat 1, a certain sound or light is generated for thereby alarming the error state, whereby a user recognizes the error state and takes a certain measurement.

Switching units S1 through S3 are connected to still another output terminal of the controller 7 for switching the AC power, DC power or a blasted and rectified power to the power apparatus 28. Here, as the switching units, a device like a relay having a contact point or a semiconductor active device of a non-contact point like a TRIAC or SCR are used. Preferably, when TRIAC or SCR is used, it is possible to prevent a common noise or a noise due to a spark, and a life span of the elements is extended, and a response speed is increased.

A terminal of the switching unit is connected with an output terminal of the controller 7, and the power apparatus 28 and the electric heat cord 14 are connected with both terminals of the switching unit in series for thereby switching the power supplied to the electric heat cord 14.

When a user sets a heating temperature by operating the temperature setting unit 26 of the controller 7, a reference temperature voltage(or current) is inputted into the controller 7, and the current temperature voltage(or current) of the indoor detected by the indoor temperature detector 10 is inputted into the controller 7 and is compared with the reference temperature voltage(or current). If the temperature value inputted from the indoor temperature detector 10 is smaller than the set temperature value, the controller 7 outputs a switching signal, and the switch is turned on, and the power is supplied to the electric heat cord 14.

Therefore, as the electric heat cord 14 is heated, the temperature of the regenerative material is increased, and the increased heat is transferred to the heating hose 11, the electric heat plate 3, the silver fiber layer 4, the yellow soil cover layer 5 and the finishing material 6 in sequence, so that the heating operation of the indoor is implemented at a set temperature.

If the temperature value of the indoor detected by the indoor temperature detector 10 exceeds the set reference temperature range, since a switching signal is not outputted to the output unit of the controller 7, the switch is turned off, and the power supplied to the electric heat cord 14 is disconnected, and the heating of the electric heat cord 14 is stopped, and the temperature of the regenerative material is decreased.

Therefore, the indoor temperature does not exceed the set temperature, and the power supplied to the electric heat cord 14 is controlled, so that it is possible to implement a certain heating operation that a user wants. The indoor temperature, the temperature of the regenerative material and the temperature value of the setting unit are displayed on the LCD panel 22 in digital numerals.

The tolerance of the reference temperature that the controller 7 permits is set in a range of ±1° C.˜±3° C., so that the electric heat cord 14 does not sensitively operate. If the temperature inputted from the indoor temperature detector 10 is below the above tolerance range, the power is automatically supplied to the electric heat cord 14.

[First Embodiment]

As shown in FIGS. 3A and 3B, the electric heat cord 14 is provided in the center of the bottom of the heating hose 11, and the electric heat cord 14 is connected with the controller 7 adapted to control the temperature of the electric heat cord 14 using the connection member 8.

The adiabatic member 2 is preferably formed of a certain adiabatic of a polyurethane foam or silicon material having an adiabatic property and is formed in a rectangular shape or regular square shape having a certain thickness. A hose groove is formed on the adiabatic member 2 for installing the heating hose 11 therein in a zig-zag shape.

A regenerative material is filled in the interior of the upper hose 12 for thereby regenerating the heat. The heating hose 11 is formed of a synthetic resin material such as PE(poly ethylene) or PP-C(poly propylene-copolymers) having a thermal endurance, flexibility, durability, and ant-corrosion property. The heating hose 11 is arranged the grooves formed in the adiabatic member 2.

The heating hose 14 is processed based on a triple protection coating insulation process like a silicon coating on a conductive material like a nichrome cord or a copper cord.

As shown in FIG. 3C, a plugging cap 18 which is adapted to hermetically seal both ends of the heating hose by a high frequency welding method using a synthetic resin material like PE or PP-C. In a preferred embodiment, an inner side of the plugging cap 18 is threaded, and the corresponding end of the heating hose 11 is threaded, and a rubber packing is inserted therein for thereby hermetically engaging the threaded portions of the same. In the case that the heating hose 11 is formed in a plastic forming method, the plugging cap 18 may be integrally formed. A hole is formed in the upper portion of the heating hose 11, and a regenerative material is filled thereinto, and the hole is closed.

[Second Embodiment]

FIG. 6A is a perspective view illustrating a heating hose of an electric mat according to a second embodiment of the present invention, FIG. 6B is a disassembled view of FIG. 6A, FIG. 6C is a cross sectional view which illustrates a heating hose of an electric mat and is taken along line IV-IV′ of FIG. 6A, and FIG. 6D is a view illustrating an example that the construction of FIG. 6A is adapted to a wrinkling light weight plate.

As shown therein, the heating hose 11 is formed of an upper hose 12 in which a concave portion 16 is formed in the center in a semi-circular shape in a longitudinal direction, and a lower hose 13. An engaging groove 15 is formed in the upper hose, and an engaging portion 17 is formed in the lower hose 13. The heating hose 11 in which the upper and lower hoses 12 and 13 are engaged is assembled in a circular shape. The center of the heating hose is closely contacted with the concave portions 16, 16′ of the upper and lower hoses 12 and 13 for thereby forming a circular space therein.

The electric heat cord 14 is provided in the hose grooves for an installation in the adiabatic member 2 in a zig-zag shape, and a concave portion of the upper hose 12 is positioned in the upper portion of the electric heat portion 14.

A regenerative material is filled in the heating hose 12 and the lower hose 13, respectively, and the heating hose 11 is formed of a synthetic resin material like PE(Poly Ethylene) or PP-C(Poly Propylene-Copolymers) having a thermal endurance, a flexibility, a durability and an anti-corrosion property, which can endure a temperature of 80° C.

The temperature detector 9 of FIG. 6C is installed in the upper hose or the lower hose. The temperature detector 9 controls the power supplied to the electric heat cord 14 based on a temperature of the regenerative material for thereby adjusting the temperature of the heating hose 11, 11′.

FIG. 6D is a view illustrating an example that the electric mat 1 is inserted between the wrinkling light weight plates 3′. Here, the electric mat 1 may be surrounded in such a manner that one or more electric heat plate 3 or light weight steel plate 3′ may be assembled to both surface, and in the case that the electric mat 1 itself is built in the wall, it is preferred to use an electric plate of a metallic material having a high thermal conductivity based on an outer appearance and heat efficiency.

[Third Embodiment]

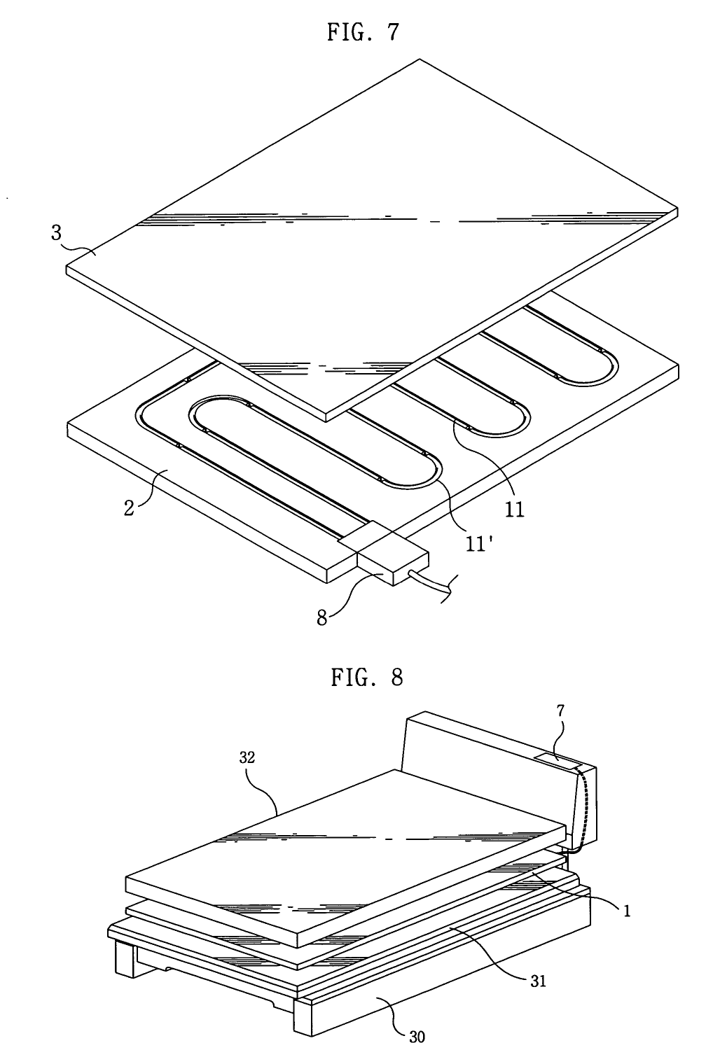

As shown in FIG. 7, a straight line shaped hose 11 is accommodated in a straight line portion of the hose groove formed in the adiabatic member 2 instead of integrally forming the heating hose 11, and a curve shaped hose 11′ is accommodated in a curved portion of the hose groove.

The electric heat cord 14 is processed based on a triple protection coating insulation process such as a silicon coating, etc. on a conductive material like a nichrome cord or copper cord and is accommodated in a concave portion of a semi circular shape formed in the upper hose 12 and the lower hose 13, respectively. As shown in FIG. 7, when the straight line shaped and curve shaped lower hose 13 is provided along a hose groove of the adiabatic member, the electric heat cord 14 is placed in a concave portion 16′ of the lower hose 13, and the upper hose 12 is engaged to the lower hose 13 for thereby implementing a full engagement.

In addition, since the temperature detector 9 is installed in the heating hose 11 for detecting the temperature of the regenerative material, when the temperature value is in a range of 90° C.˜100° C., since the controller 7 turns off the switching units S1, S2 and S3, an over heating is prevented. However, when the electric mat 1 is over heated, and it is impossible to control the same, an alarming signal is outputted from the alarming unit 25, so that a user can do a certain measurement.

As shown in FIG. 6C, the regenerative material detector 27 is connected to an input portion of the controller 7 for detecting whether there is provided a regenerative material. When the regenerative material is exhausted or is used by a certain degree, the alarming unit 25 connected to the output of the controller 7 generates a visual or audible alarm, so that the user recognizes the problem and takes a certain action. Therefore, it is possible to prevent the electric heat cord 14 from being disconnected or the heating hose 11 from being melted.

In the case that the user leaves the home in which the heating apparatus according to the present invention is installed, for a long time due to a tour or outing, the power saving mode is selected, and the AC power(AC 110V or 220V) supplied to the electric heat hose 14 is rectified through the diode D based on a half wave method for thereby saving the energy. Namely, a battery 20 and a battery charger are connected with the output terminal of the controller 7, and the power is connected with the front end of the battery charger 21, and a switching unit S3 is connected between the battery 20 and the electric heat cord. Therefore, at a usual time, the AC is supplied, and in an emergency state, a DC power is supplied from the battery 20.

The controller 7 is wire-connected by the connection member 8. If necessary, a wireless communication port may be provided in an output terminal of the electric mat 1, and a communication port may be installed in an input terminal of the controller 7 for thereby controlling the controller 7 based on a wireless method.

The LCD apparatus 22 is connected with the controller 7, and the indoor temperature, the setting temperature and the temperature of the interior of the regenerative material are displayed in numerals, so that it is possible to recognize the operation states of the temperature value and power indication by operating the controller 7.

[Fourth Embodiment]

FIG. 8 is a perspective view illustrating the construction that the electric mat according to the present invention is adapted to a bed. In this embodiment, the electric mat 1 according to the present invention is adapted to the bed in such a manner that the electric mat 1 is provided between a support 31 and a mattress 32 of the bed 30.

When the electric mat 1 is provided between the support 31 and the mattress 32 in the above manner, a heat and infrared ray generated in the electric mat 1 transmit the mattress 32 and are transferred to the user of the bed, so that the user can sleep comfortably.

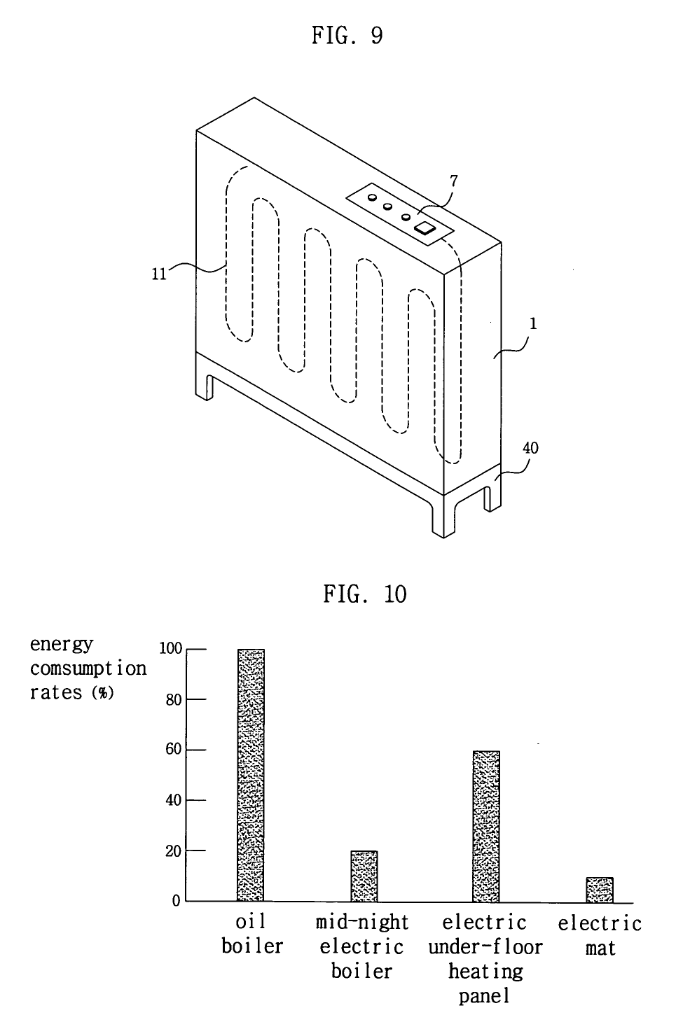

FIG. 9 is a view illustrating an example that the electric mat according to the present invention is adapted to a radiator of an indoor. The electric mat of the present invention may be used as a radiator for heating the indoor. In particular, the electric mat according to the present invention may be used as a heating radiator for a motel, a pension, or a movable type house. In addition, the electric mat according to the present invention may be used for a conventional radiator. In the case that the electric mat is used in a large size factory or an office, a certain number of the electric mats may be combined for thereby implementing a desired effect with respect to a desired area and space.

As shown in FIG. 9, the electric mat 1 is installed on the support 40. The heating hose 11 is provided in the interior of the electric mat 1, and the controller 7 is installed in the upper portion of the same for thereby controlling the temperature of the electric mat 1 and checking various operation states. In this case, since the heat radiated from the electric mat 1 is directly discharged to the outside, the heating efficiency is enhanced, and since the infrared ray is radiated from the electric mat 1, it is very helpful to a health of a human body.

FIG. 10 is a graph which is obtained based on a result of the data measured by operating four kinds of heating apparatuses 5 hours everyday for fourth months in order to check the effects of the present invention. For example, an electric mat according to the present invention is installed in a house having an area of 33 m² with two rooms. At this time, the electricity rate for 30 days was about 55,000won(about 50US$ per month). As a result, the electric mat according to the present invention can save the energy rate by ¼ compared to an oil boiler. Therefore, the electric mat according to the present invention is very economical.

For example, assuming that the energy rate of the conventional oil boiler was 100%, the mid-night energy saving boiler consumes 20%, the electric heating system panel consumes 60%, and the electric mat according to the present invention consumes 10%.

As described above, in the electric mat according to the present invention, since the heating hose having a regenerative material therein and the electric heat cord do not contact each other, it is possible to prevent a corrosion of the electric heat cord due to the regenerative material, for thereby preventing a fire and power leakage.

In addition, in the present invention, it is possible to eliminate various bacteria in the indoor using a heating hose having a regenerative material therein and an anti-bacteria property and anti-toxic property of the silver fiber layer. In addition, since an infrared ray is radiated from the regenerative material, it is helpful to a human body. Since the power consumption is relatively lower compared to the conventional heating apparatuses, it is possible to save the energy.

In the present invention, since it is possible to separately assemble the straight line portion and curve line portion of the heating hose, the length of the electric mat may be adjustable, and the construction process is very simple.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In an electric mat which includes a heating hose in which a regenerative material is filled, an electric heat cord provided in the electric heat hose, a temperature detector and an indoor temperature detector for detecting a temperature of the interior of a regenerative material, an electric mat using a regenerative material, comprising:
an adiabatic member installed in a bottom of the electric mat;
a heating hose provided on the adiabatic member at a certain interval;
an electric heat cord which is arranged in a concave portion of the heating hose;
an electric heat plate stacked on an upper portion of the heating hose;
a silver fiber layer stacked on an upper portion of the heating hose;
a yellow soil cover layer arranged on an upper portion of the silver fiber layer;
a finishing member which covers an upper side of the yellow soil cover layer;
a controller for controlling a temperature of the electric mat; and
a connection means for engaging the electric mat and the controller.

2. An electric mat of claim 1, wherein a certain space is formed in a center of a bottom surface of the heating hose, and another surface of the same is formed in a semi circular shape or a rectangular shape, and an electric heat cord is arranged in a space formed in the concave portion in a longitudinal direction, and a plugging cap hermetically seals both ends of the heating hose.

3. An electric mat of claim 1, wherein said heating hose is formed of an upper hose and a lower hose each having a concave portion formed in a center in a longitudinal direction, and said upper hose has an engaging groove formed in one side, and said lower hose has an engaging portion corresponding to the engaging groove, and an electric heat cord is inserted in the center, and the engaging groove and the engaging portion are engaged each other, and then a plugging cap is hermitically engaged to both ends of the heating hose.

4. An electric mat of claim 1, wherein said heating hose is assembled in such a manner that a straight line type heating hose and a curve line type heating hose are engaged each other.

5. In an electric mat which includes a heating hose in which a regenerative material is filled, and an electric heat cord installed in the interior of the heating hose, an electric mat, comprising:
a heating hose which is provided in a center of the electric mat in a zig-zag shape; and
an electric heat cord which is provided in a concave portion formed in the heating hose in a longitudinal direction, wherein both surfaces of the electric mat is stacked by a wrinkled light weight plate or a plane type electric heat plate.

6. An electric mat of claim 1, wherein said regenerative material is a mixture formed of NaCl of 60˜70 weight %, H₂O of 20˜30 weight %, NaOH of 5 weight %, and CH₃COOH of 5 weight %.

7. An electric mat of either claim 2 or claim 3, wherein said plugging cap of the heating hose is formed of a synthetic resin material for preventing a regenerative material from being leaked from a heating hose.

8. An electric mat of claim 1, wherein a battery and a battery charger are connected to an output terminal of the controller, and a power is connected to a front end of the battery charger, and a switching means is connected between the battery and the electric heat cord, so that at a usual time an AC is supplied, and in an emergency state, a DC is supplied from the battery.

9. An electric mat of claim 1, wherein a regenerative material detector is provided in an input terminal of the controller for thereby detecting whether a regenerative material remains, so that when a regenerative material is exhausted or is used by a certain degree, an alarm is generated through an alarming means connected to an output of the controller.

10. An electric mat using a regenerative material of claim 1 or 5 is adapted to a radiator adapted for an indoor heating or is adapted as a heating unit for a motel, a pension or a movable house.
